(19) United States
(12) Patent Application Publication
(10) Pub. No.: US 2010/0039271 A1
(43) Pub. Date: Feb. 18, 2010

(54) System and Method for Leak Detection

(76) Inventors: Myles Izikoff, Hendersonville, TN (US); Michael Stumpf, Seven Mile, OH (US); Howard Samson, Antioch, TN (US)

Correspondence Address: LANIER FORD SHAVER & PAYNE P.C., P O BOX 2087, HUNTSVILLE, AL, 35804-2087, US

(21) Appl. No.: 12/542,416

(22) Filed: Aug. 17, 2009

Related U.S. Application Data
(60) Provisional application No. 61/089,248, filed on Aug. 15, 2008.

(51) Int. Cl. G08B 21/00; G01M 3/24

(52) U.S. Cl. 340/605; 73/40.5 A

(57) ABSTRACT

A leak detection apparatus has a transducer arranged for detection of sound, the transducer translating the sound into an analog signal and a display device. In addition, the leak detection apparatus has logic configured to detect the analog signal and display to the display device a gain range corresponding to the signal.

### CROSS-REFERENCE TO RELATED APPLICATION

This application claims the benefit of U.S. Provisional Application No. 61/089,248 filed on Aug. 15, 2008, the entire contents of which are herein incorporated by reference.

### FIELD OF THE INVENTION

The present invention relates generally to the field of leak detection, and specifically to a system and method for ultrasonic leak detection.

### BACKGROUND AND SUMMARY

An apparatus in accordance with an embodiment of the disclosure comprises a hand-held ultrasonic leak detector. The leak detector comprises an ultrasound receiver that receives ultrasound signals indicative of leaks in pressurized pipes, for example, defective bearings, and or corona discharge from electrical components.

### DESCRIPTION OF THE DRAWINGS

FIG. 1A is a front perspective view of a leak detection apparatus in accordance with an embodiment of the present disclosure, showing the bottom of the apparatus.

FIG. 1B is a perspective view of the leak detection apparatus of FIG. 1A showing two listening devices attached thereto.

FIG. 2 is a front perspective view of a leak detection apparatus in accordance with an embodiment of the present disclosure, showing the top of the apparatus.

FIG. 3 is a block diagram depicting the system components of the leak detection apparatus depicted in FIG. 1.

FIG. 4 depicts use of the leak detection apparatus depicted in FIG. 1.

FIG. 5 depicts three exemplary embodiments of the receiver head according to an embodiment of the present disclosure.

FIG. 6 depicts an exemplary display device of the apparatus depicted in FIG. 1.

FIG. 7 is a block diagram depicting exemplary circuitry of the leak detection apparatus depicted in FIG. 1.

FIG. 8 is a block diagram depicting exemplary gain/active filter circuitry of the exemplary circuitry of FIG. 7.

FIG. 9 is a flowchart illustrating an exemplary method in accordance with an embodiment of the present disclosure.

### DETAILED DESCRIPTION

The present disclosure is best understood by referring to the drawings. The elements of the drawings are not necessarily to scale, emphasis instead being placed upon clearly illustrating the principles of the disclosure.

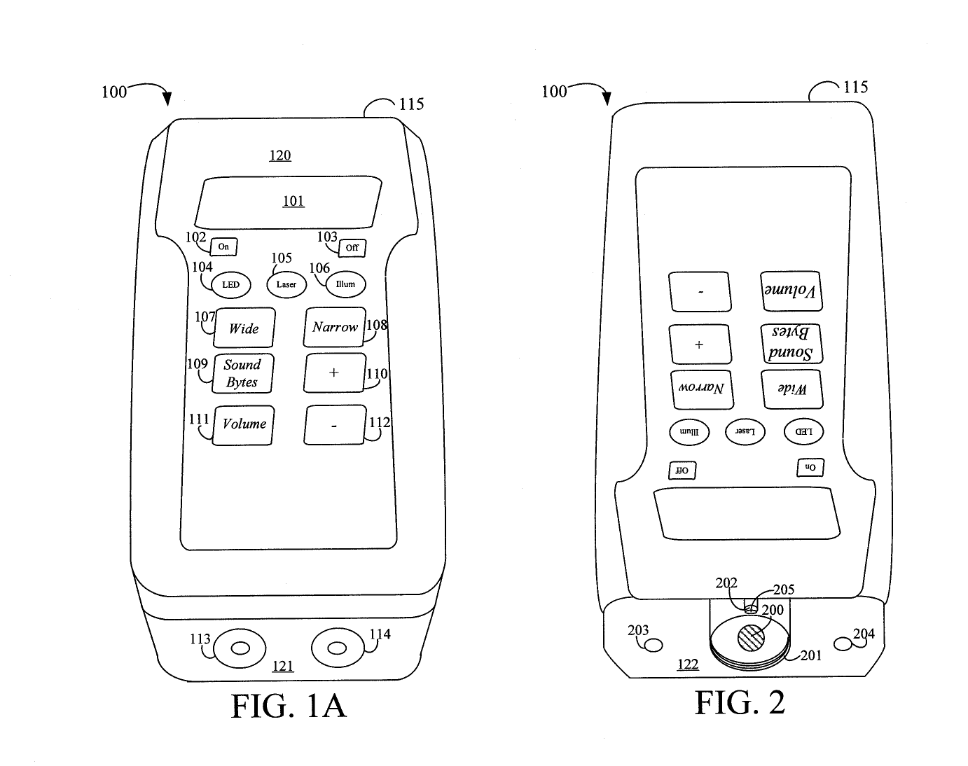

FIG. 1A is a front perspective view of a leak detection apparatus 100 in accordance with an embodiment of the present disclosure. The leak detection apparatus 100 comprises a housing 115 that houses electronic components described further herein.

The leak detection apparatus 100 comprises a front side 120. The front side 120 comprises a display device 101, which can be, for example, a light emitting diode (LED) display device or a liquid crystal display (LCD) device. During operation, the display device 101 displays information relative to operation of the leak detection apparatus 100.

The leak detection apparatus 100 further comprises a plurality of control buttons 102-112. Each of these control buttons 102-112 is described further with reference to the operation of the leak detection apparatus 100.

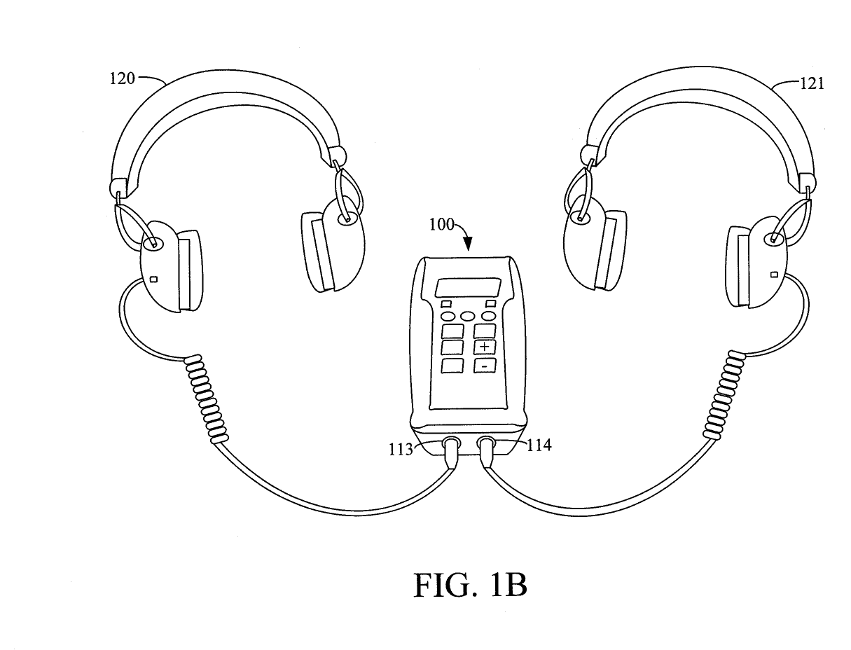

In this regard, the “On” button 102 and the “Off” button 103 are for activating and deactivating the leak detection apparatus 100. In addition, the leak detection apparatus 100 further comprises the “LED” button 104 for lighting of the display device 101, a “Laser” button 105 and an “Illum” button 106, which are described further with reference to FIG. 2.

The leak detection apparatus 100 comprises the “Wide” button 107 and the “Narrow” button 108. As will be described further herein, a signal (not shown) produced by sound detected by the leak detection apparatus 100 is filtered such that it is centered about a particular frequency, e.g., 38.4 kilo Hertz (kHz). In a first stage, the signal is filtered such that some noise components within the signal are filtered out in a first bandwidth. In a second stage, the signal is further filtered such that additional noise components within the signal are filtered out. If the “Wide” button 107 is selected, that signal generated by filtering in the first stage is audibly transmitted to a user (not shown) of the leak detection apparatus 100. If the “Narrow” button 108 is selected, the signal generated by filtering in the second stage is audibly transmitted to the user. Notably, each of these buttons 107, 108 is selected to control the audible signal transmitted for listening by a user (not shown).

In this regard, the “Wide” button 107, when selected, relatively increases the listening area of the leak detection apparatus 100. Whereas, the “Narrow” button 108, when selected, decreases the listening area of the leak detection apparatus 100. Actuating the Wide button 107 causes the apparatus to operate in the normal field of reception and is generally in the 40K hertz spectrum. When the Narrow field button 108 is selected, the apparatus 100 narrows the field of reception which reduces or eliminates competing noise. In this regard, a user (not shown) may use the apparatus 100 with the “Wide” button 107 actuated to narrow in on a potential leak location, and then select the “Narrow” button 108 to narrow the field.

In one embodiment of the apparatus 100, the Narrow mode setting narrows the reception spectrum down to around 38.4 kilohertz, plus or minus 1 kilohertz. In this regard, the apparatus 100 contains an 8-pole filter (not shown), that narrows the spectrum accordingly. When the apparatus 100 is in Wide mode, the 8-pole filter is bypassed so that a receiver 200 in the apparatus 100 receives all of the signals that the transducer (not shown) in the apparatus is capable of receiving. The transducer generally receives signals at 40 kilohertz, plus or minus 2 kilohertz; therefore a wider range of signals is received when the apparatus 100 is in Wide mode.

The leak detection apparatus 100 further comprises a bottom side 121 comprising a plurality of ports 113 and 114. With reference to FIG. 1B, the ports 113, 114 are arranged and configured for receiving one or more listening devices 120, 121, respectively. For example, headphones or earphones may be connected to the ports 113 and 114. A user holding the apparatus 100 can hear sounds received and/or generated by the apparatus 100, which is described further herein.

With reference to FIG. 1A, the apparatus 100 further comprises a “Sound Bytes” button 109. In one embodiment, when the “Sound Bytes” button 109 is selected, the apparatus 100 transmits training sounds to the ports 113 and 114 for listening by a user using the listening devices. In this regard, the apparatus 100 may display a list of sounds available for hearing that includes, for example, sounds of corona discharge or sounds of an air leak. Using a “+” button 110 and a “−” button 112, the user can scroll through the list of available sounds and select a sound from the list that the user desires to hear. Upon selection, the apparatus 100 generates sound indicative of, for example, a corona discharge or an air leak, and plays the sound for the user via the listening devices connected to the ports 113 and 114. The “Volume” button 111 can be used to increase and/or decrease the volume at which the user hears generated sounds.

FIG. 2 is a front perspective view of the leak detection apparatus 100 showing the top side 122 of the apparatus. Notably, the top side 122 comprises a transducer 200 embedded within a threaded cylindrical structure 201. The structure 201 is comprises female threads for receiving receiver heads that enable directed use of the transducer 200, and the implements are described further herein. In one embodiment, the transducer 200 is recessed within the structure 201; however, the transducer 200 may be located differently in other embodiments of the apparatus 100.

The leak detection apparatus 100 further comprises a laser 202 and a plurality of lighting devices 203 and 204. During operation, the user can select the “Illum” button 106, which activates the lighting devices 203 and 204. Therefore, when the apparatus 100 is being used in a dimly lit environment, e.g., in an electrical panel when determining corona discharge, the lighting devices 203 and 204 illuminate the field of view.

When the “Laser” button 105 is activated, the laser 202 emits light in a direction in which the top side 122 of the apparatus 100 is being pointed. In this regard, light is emitted from the laser 202 in the same direction in which the top side 122 of the ultrasound receiver 200 is directed. Thus, the beam (not shown) emitted from the laser 202 falls approximately on an object (not shown) in the direction in which the transducer 200 is listening. Therefore, the laser 202 “points” to the object that is being listened to by the transducer 202.

The apparatus further comprises a detector 205. The detector 205 can be used to receive reflected light from the laser 202. Such reflected light can be used to determine, for example, based upon the distanced traveled by light emitted from the laser 202, the distance of an object from the apparatus 100. This distance can be displayed to the display device 101.

In another embodiment, the detector 205 is an infrared sensor. In such an embodiment, the detector 205 may be used to determine the temperature of an object that is being pointed to by the laser 202.

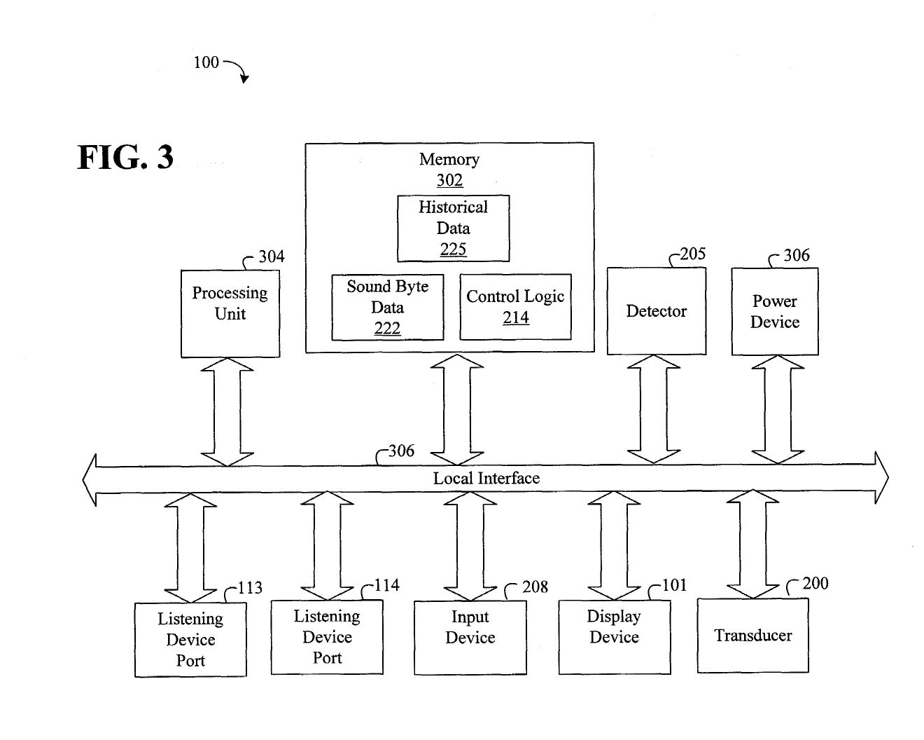

FIG. 3 depicts an exemplary apparatus 100 of the present disclosure. The exemplary apparatus 100 generally comprises the transducer 200, the display device 101, and the ports 113, 114 for listening devices 120, 121 (FIG. 1B), as described hereinabove with reference to FIGS. 1A, 1B and 2. In addition, the apparatus 100 further comprises a processing unit 304 and an input device 208, all communicating over a local interface 306.

In one embodiment, the input device 208 is a keypad (not shown) that comprises the plurality of buttons 102-112 (FIGS. 1 and 2). Other input devices 208 are possible in other embodiments.

In one embodiment, the listening device 208 is headphones and/or earphones, which connect to the ports 113 and 114 (FIG. 1). Other listening devices 208 are possible in other embodiments. For example, the apparatus 100 may further comprises a radio transmitter that wirelessly transmits data to wireless receivers worn by a user (not shown).

The apparatus 100 further comprises a power device 306. The power device 306 may be, for example, a rechargeable battery pack that powers the components of the apparatus 100.

The apparatus 100 further comprises control logic 214. The control logic 214 can be software, hardware, or a combination thereof. In the exemplary apparatus 100, the control logic 214 is shown as software stored in memory 302. The memory 302 may be of any suitable type of computer memory known in the art, such as RAM, ROM, flash-type, and the like.

As noted herein, the control logic 214 is shown in FIG. 3 as software stored in memory 302. When stored in memory 302, the control logic 214 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The processing unit 304 may be a digital processor or other type of circuitry configured to run the control logic 214 by processing and executing the instructions of the control logic 214. The processing unit 304 communicates to and drives the other elements within the apparatus 100 via the local interface 306, which can include one or more buses.

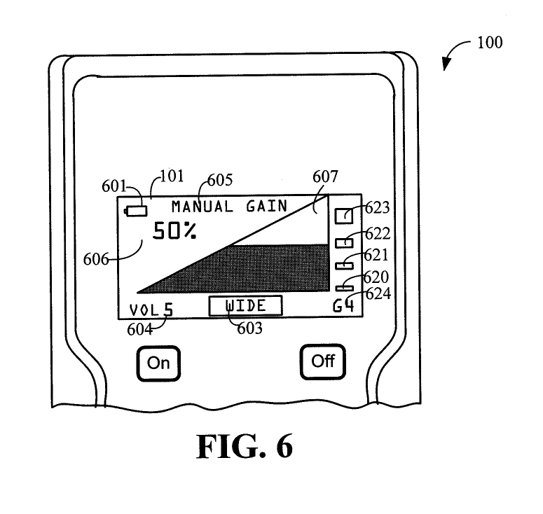

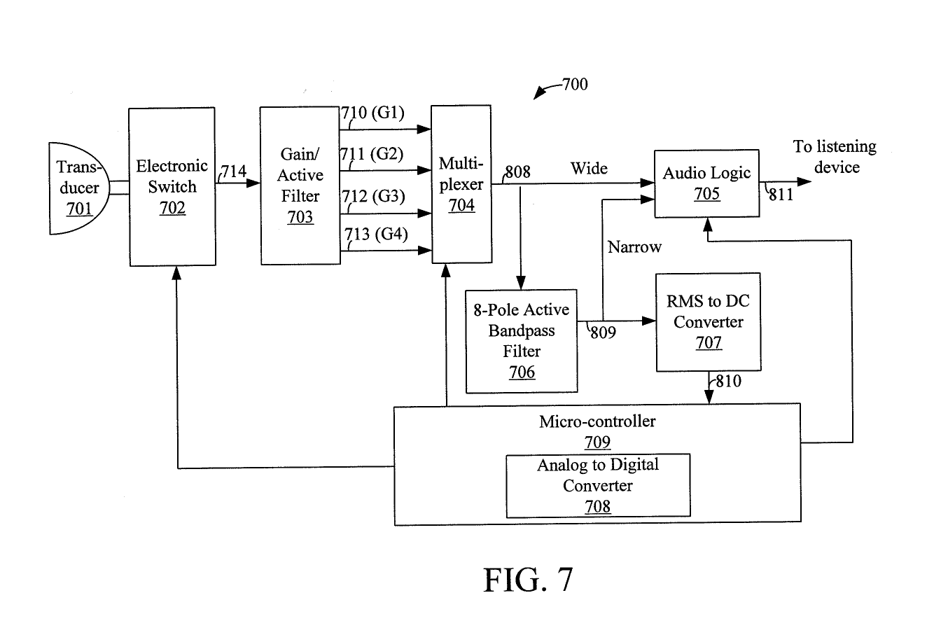

During operation, the user activates the apparatus 100 via the input device 208, which can be comprised of one of the plurality of buttons 102-112 (FIGS. 1 and 2). Upon activation, the control logic 214 calibrates the transducer 200, which is described further with reference to FIGS. 6, 7.

When the user activates the “Wide” button 107 (FIG. 1), the control logic transmits the signal, as described hereinabove, to the listening device ports 113, 114. In addition, the control logic 214 displays to the display device 101 data indicating the percentage of saturation of the electronics with a sound signal received by the transducer 200. When the user selects the “Narrow” button 108 (FIG. 1), the control logic 214 filters out noise being received by the transducer 200. In addition, the signals being received via the transducer 200 are transmitted to the listening device 208 so that the user can recognize whether there is a recognizable sound, e.g., a corona discharge or an air leak.

When the user activates the “Sound Byte” button 109 (FIG. 1), the control logic 214 displays a list of identifiers identifying sound byte data 222 stored in memory 302. As an example, the sound byte data 222 may be a plurality of .wav files indicative of sounds common, for example, in an automotive plant. The user can select to hear one of the sounds, e.g., the stored sound of a corona discharge, via the input device 208. The control logic 214 plays the selected sound for the user via the listening device 208.

The control logic 214 may further store historical data 225 identifying particular tests that have been performed on an identified object. For example, the data 225 may indicate that a test has been performed on a pipe identified as “Pipe 1.” The historical data 225 can store the identifier Pipe 1 associated with an ultrasound reading taken from the transducer 200 and data indicative of how far away the reading was taken. Thereafter, the user can return to the same Pipe 1 and, based upon the previously generated data, take another reading at the same distance to determine if a detected leak has increased or changed.

As another example, the apparatus 100 may be used to capture sound and temperature data (not shown) related to a particular bearing. In this regard, the user may obtain data indicative of a sound reading from the transducer 200 and a temperature reading from the detector 205. This data may be stored as historical data 225. In the future, the user can recall the historical data 225 and compare it with a new sound reading and temperature reading to determine if the bearing has degenerated.

The control logic 214 further initiates and controls the calibration of the apparatus 100. In operation, the apparatus 100 calibrates itself based information obtained from internal electronics. In this regard, when the apparatus 100 first powers on, the calibration routine goes through each of four gain ranges and bypasses the transducer and collects information about the DC offset in each gain range. In this process, the “noise floor” in each gain range is obtained and recorded with no signal being received by the transducer 200. After the calibration sequence is complete, the transducer 200 is put back online and the noise floor values are subtracted for each range. This process is described further with reference to FIGS. 6, 7.

The highest gain range employs the use of a high gain circuit that amplifies the input signal 40,000 times. Signals received on the low end of the spectrum are as small as 0.3 micro volts and thus require high amplification in order to be able to translate the signal into the audible range. When this type of gain is used in circuits, the circuits tend to drift with temperature and time and the like. When the gain is very high, even small deviations in temperature, for example, can result in a large offset in the circuitry. Signals may be varied by as much as a million to one on the high end, and this much gain would saturate all of the electronics. Therefore, the signal is attenuated automatically based upon the size of the signal coming in. For example, if the incoming signal is too big for a gain range, the signal is automatically attenuated until the signal is just large enough so that it is in a linear range. If it is too small, gain is added automatically and the signal is raised up as far as possible without over-ranging.

In this regard, control logic 214 directs a signal through the appropriate amplifiers based upon the size of the signal. The signal is maintained into a linear range of the amplifiers to avoid introducing harmonics into the signal.

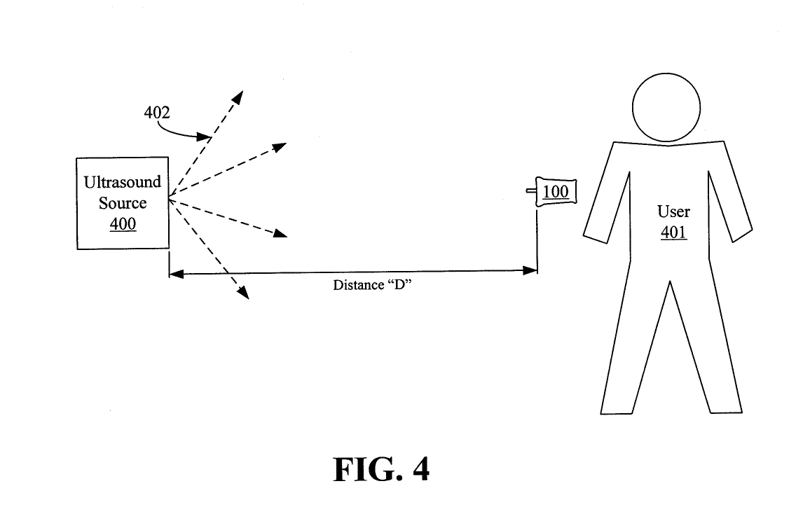

FIG. 4 depicts use of the apparatus 100, for example in the field of maintenance. Notably, a user 401, e.g., a maintenance technician, may desire to determine if there is a leak in the vicinity of the user 401. The user 401 activates the leak detection apparatus 100 via the “On” button 102 (FIG. 1).

Upon activation, the transducer 200 (FIG. 2) begins receiving data indicative of ultrasound from the vicinity. Thus, there can be a sound source 400 within the vicinity of the user 401 emitting ultrasound signals 402. The sound source 400 can be, for example, a transmitter that has been placed within a closed container. In addition, the sound source 400 can be a leaking pipe or an electrical box wherein a connection is experiencing corona discharge.

The detector 205 (FIG. 2) in the apparatus 100 can determine the distance “D” between the ultrasound source 400 and the user 401 by receiving light reflected from the laser 202 (FIG. 2). The detector 205 can be used to receive reflected light from the laser 202. The distance “D” can be displayed to the display device 101 (FIG. 1).

Based upon data displayed to the display device 101 (FIG. 1), the user 401 can determine whether there is a signal being received indicative of a leak, e.g., in the 40K Hertz range. In addition, the user 401 can also wear the listening device 120 or 121 (FIG. 1B) attached to listening ports 113, 114 (FIG. 3), and determine, based upon what he hears, whether there is a notable signal in the vicinity. If the user 401 is unsure about the nature of the sound that he hears, the user 401 can select to hear, e.g., a sample air leak from the sound byte data 222 (FIG. 3) and audibly compare what he is hearing with the sounds stored in memory 302.

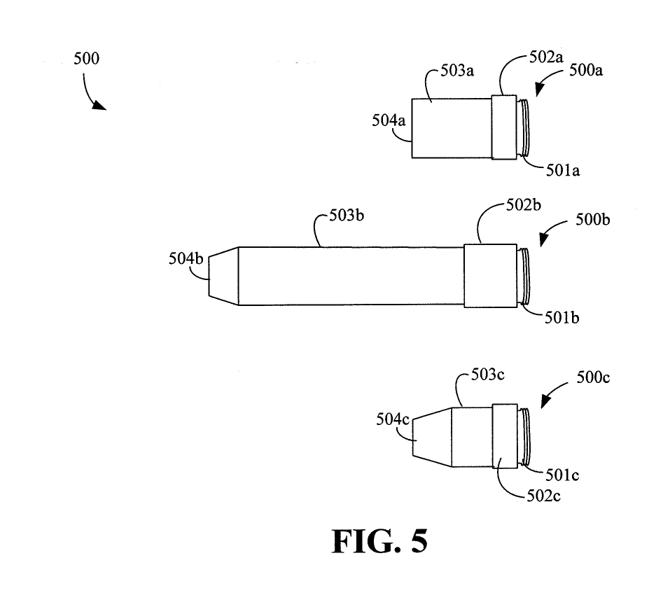

FIG. 5 depicts three exemplary embodiments 500a, 500b, and 500c of the receiver head 500 of the present disclosure. The receiver head 500 connects to the threaded cylindrical structure 201 (FIG. 1) on the apparatus 100 (FIG. 1) and facilitates reception of ultrasound signals (not shown). In this regard, the receiver head 500 extends the “reach” of the apparatus 100.

The receiver head 500a comprises a threaded end 501a, a gripper portion 502a, a shaft 503a, and a receiving end 504a. In this embodiment, the threaded end 501a comprises male threads that mate with the female threaded cylindrical structure 201 (FIG. 1). The gripper portion 502a comprises a raised generally rough surface that is easily grippable by the user's fingers to install and remove the receiver head 500a from the apparatus 100.

The shaft 503a is a generally cylindrical extender with a hollow, generally cylindrical bore and is integrally formed with the threaded end 501a, the gripper portion 502a, and the receiving end 504a. In one embodiment, the shaft 503a is one and one-half (1-½) inches long with a hollow bore. In other embodiments, other dimensions can be used. The shaft 503a may be fabricated from stainless steel or other rigid materials. In one embodiment the shaft 503a is fabricated from a non-conductive material such as Delrin so as to avoid arcing when testing for corona discharge of electrical circuits or in electrical panels.

In another embodiment, the shaft 503a and/or the receiving end 504a is fabricated from a magnetic material. A magnetic receiving end 504a may be desirable when testing certain components, such as bearings, because the end 504a is attracted to and may temporarily affix to the jacket of the bearing. While the end 504a is temporarily affixed to the component under test, the sound quality may be greater and the incidence of undesirable sounds being received may be decreased.

The receiving end 504a is open-ended for pointing at and receiving ultrasonic signals. The receiving end 504a is a generally straight cylindrical end. As discussed below with respect to the receiving end 504b, other embodiments have tapered ends.

The receiver head 500b comprises a shaft 503b that is longer than the shaft 503a of the receiver head 500a. A longer shaft may be desirable, for example, when testing for leaks among a plurality of pipes in a small area. In this regard, the elongated shaft 503b may fit in amongst multiple pipes to test around joints and seals. In one embodiment, the shaft 503b is five inches in length, though other lengths could be used.

The receiver head 500b further comprises a tapered receiving end 504b. The tapering of the receiving end 504b serves the purpose of narrowing the end to enable it to squeeze into tighter spaces. The tapering further serves to funnel the ultrasonic signals into the receiver 200 and also reflects undesirable signals away from the receiver head 500b. The receiver head 500c also comprises a tapered receiving end 504c.

FIG. 6 depicts an exemplary display device 101 according to an embodiment of the leak detection apparatus 100. The display device 101 comprises a battery level indicator 601 which displays graphically the amount of battery power remaining. Display device 101 further comprises a volume indicator 604 which displays the current volume setting of the leak detection apparatus 100. A mode indicator 603 displays whether the apparatus 100 is in Wide or Narrow mode, as described herein. Signal intensity bars 620-623 and a signal intensity graphical window 607 display graphically the intensity level of a signal received. In addition, an indicator 624 identifies in which gain range the leak detection apparatus is operating.

The display device 101 further comprises a saturation level indicator 606 that indicates the saturation level of the electronics. The display device 101 further comprises a mode indicator 605 that indicates that the apparatus 100 is in “Manual Gain” mode.

FIG. 7 depicts an exemplary circuit 700 in accordance with an embodiment of the leak detection apparatus of FIG. 1. The circuit comprises a transducer 701, an electronic switch 702, and a gain/active filter 703. In addition, the circuit comprises a multiplexer 704, an 8-pole active bandpass filter 706, a root mean square (RMS) to digital converter 707, and an analog to digital converter 708. The circuit 701 is further controlled by a micro-controller 709.

The transducer 701 detects sound present in the area of the transducer 701, i.e., the transducer 701 listens for sound. When the leak detection apparatus 100 is initially powered on, the circuit 700 enters calibration mode. In calibration mode, the transducer 701 is disconnected from the circuit 700. In this regard, when the circuit 700 is powered on, the micro-controller 709 transmits a signal to the electronic switch 702, and the electronic switch 702 disconnects the transducer 701 from the circuit 700.

During calibration, the micro-controller 709 grounds the electronic components within the gain/active filter 703. The micro-controller 709 then measures a plurality of direct current (DC) offset values and an inherent noise floor value for the circuit 700. The offset values and the noise floor values are eventually subtracted out of any signal received through the transducer 701.

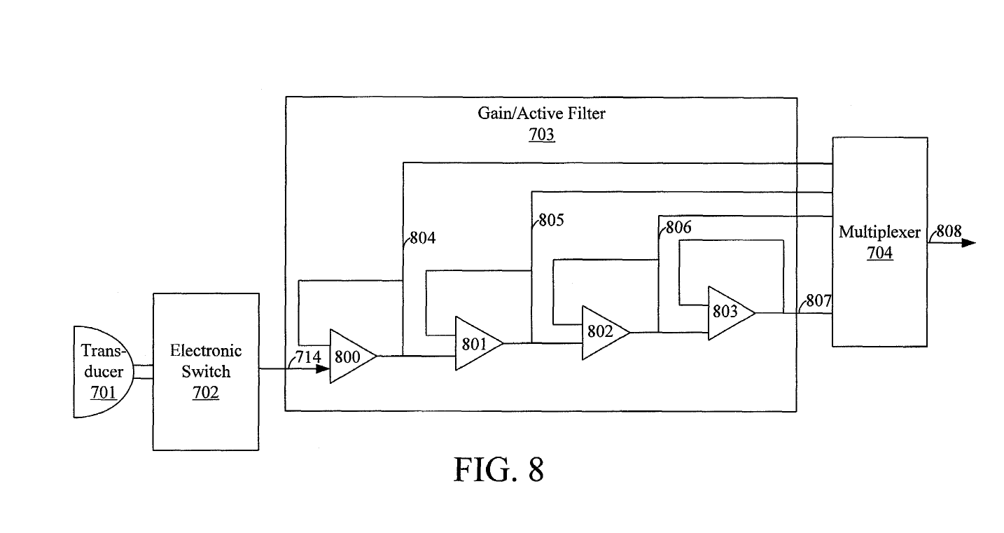

In one embodiment, the gain/active filter 703 is configured and constructed as shown in FIG. 8. In such an embodiment, the gain/active filter 703 comprises a plurality of amplifiers 800-803 arranged in a cascading fashion. Notably, each amplifier 800-803 exhibits a particular gain and each amplifier 800-803 corresponds to a differing gain range to be applied to a signal 714F(G. 7), which is described further herein. Further note that the range of the signals that the gain/active filter 703 can manipulate is in the 130 decibel (dB) range, which translates into the ability of the gain/active filter 703 handling signals in the 0.1 micro Volts (μV) to 0.5 Volts (V) range.

During calibration mode, the micro-controller 709 (FIG. 7) samples the outputs of each of the amplifiers 800-801 to determine an offset value for each amplifier. Each amplifier 800-801 comprises a power supply (not shown), and while during calibration mode the amplifiers 800-803 are grounded, there still exists some voltage offset value, e.g., 3 milivolts (mV), at the outputs of the amplifiers 800-803. Such offset value is stored by the micro-controller 709 and eventually subtracted from any signal received through the transducer 701, during operation. In addition, each of the amplifiers 800-803 generates internal noise, and the micro-controller 709 measures the noise generated by each of the amplifiers 800-803, and also subtracts a noise floor value based upon the internal noise from the signal 714 received through the transducer 701 (FIG. 7), during operation.

Referring to FIG. 7, after calibration, the micro-controller 709 transmits a signal to the electronic switch 702 and the electronic switch 702 then allows signals from the transducer 701 to be transmitted to the gain/active filter 703. The gain/active filter 703 is configured and constructed to filter frequency components in the analog signal 714 at or around 38.4 kilo Hertz (kHz).

During operation, the transducer 701 detects sound and outputs the analog signal 714 indicative of the sound received to the gain/active filter 703. Based upon the analog signal 714 received, the gain/active filter 703 generates four signals 710-713 filtered at or around 38.4 kHz, each signal exhibiting a differing gain. With reference to FIG. 8, in one embodiment, the gain/active filter 703 is constructed and configured with the four amplifiers 800-803, as described hereinabove.

The analog signal 714 (FIG. 7) is input into amplifier 800, and the amplifier 800 applies a particular gain to the analog signal 714. An output analog signal 804 of the amplifier 800 exhibiting the applied gain is transmitted to the multiplexer 704 and serves as input to the next amplifier 801 in the cascade of amplifiers 800-803. The amplifier 801 applies a particular gain to the analog signal 804. An output analog signal 805 of the amplifier 801 exhibiting the applied gain is transmitted to the multiplexer 704 and serves as input to the next amplifier 802 in the cascade of amplifiers 800-803. The amplifier 802 applies a particular gain to the analog signal 805. An output analog signal 806 of the amplifier 802 exhibiting the applied gain is transmitted to the multiplexer 704 and serves as input to the next amplifier 803. The amplifier 803 applies a particular gain to the analog signal 806, and the analog signal 806 is output to the multiplexer 704.

Referring to FIG. 7, the multiplexer 704 receives the four analog signals 804-807 from the gain/active filter 703. Additionally, each analog signal 804-807 is indicative of the analog signal 714 exhibiting a particular gain. In one embodiment, each gain exhibited by each signal 804-807 is different. Furthermore, signal 807 exhibits the greatest amount of gain, signal 806 exhibits a gain less than signal 807, but greater than signal 805, and signal 805 exhibits a gain less than signal 806, but greater than signal 804. Therefore, the gain/active filter 703 generates signals 804-807 of varying gain ranges based upon the original analog signal 714, which are input to the multiplexer 704.

The micro-controller 709 selects which analog signal 804-807 is output as the multiplexer's output 808. Such output may be referred to as the “Wide” range output signal. When the circuit 700 is powered up and calibration is complete, the analog signal 808 output from the multiplexer 704 is the analog signal 807, which is the signal exhibiting the largest amount of applied gain through the amplifiers 800-803.

The output signal 808 is transmitted to audio logic 705, which is described further herein, and the output analog signal 808 is also passed through an 8-pole active filter 706 to further eliminate extraneous noise components that may be in the signal 808. The 8-pole active filter 706 filters the signal 808 at or around 38.4 kHz and outputs another analog signal 809, which may be referred to as the “Narrow” range output analog signal.

The Narrow range output analog signal 809 is transmitted to the audio logic 705, which is described further herein, and the Narrow range output analog signal 809 is also transmitted to the root mean square (RMS) to DC converter 707. The RMS to DC converter 707 rectifies the analog signal 809, so there are no longer negative components in the signal 809. The RMS to DC converter 707 further smoothes the signal 809 to an approximate steady constant signal.

The rectified smoothed signal is output 810 that is then sampled by the A/D converter 708. Such sampling indicates the maximum voltage amplitude of the output signal 810. If the signal 810 reaches a threshold value, which is described further herein, then the micro-controller 709 transmits a signal to the multiplexer 704 to select one of the other signals 710-712 as the output 808 of the multiplexer 704. Thus, the micro-controller 709 compares the digital values obtained from the A/D converter 708 to a threshold value to determine whether the signal 808 output from the multiplexer should be switched to one of the other signals 710-712. Notably, as indicated hereinabove, initially signal 714 is output as signal 808.

In one embodiment, the threshold value is 3 Volts. Thus, if the digital value indicative of the signal 810 is substantially close to 3 Volts, e.g., if the signal is at 99% or 2.97 Volts, then the micro-controller 709 transmits a signal to the multiplexer 704, and the multiplexer 704 transmits as its output the next analog signal 712 having a smaller gain than the signal 713. This process continues throughout operation.

Note that the Wide range output signal 808 is output from the multiplexer 704, and the Wide range output signal 808 exhibits a particular gain applied by the gain/active filter 703. The output signal 808 is indicative of the input signal 714 having some noise components removed. Further note that the Narrow range output signal 809 is also indicative of the input signal 714; however, additional noise components are removed by the 80pole active bandpass filter 706 above that which was removed by the gain/active filter 703.

During operation, a user (not shown) can select the “Wide” button 107 (FIG. 1) or the “Narrow” button 108 (FIG. 1). When the “Wide” button 107 is selected, the micro-controller 709 transmits a signal to the audio logic 705 indicating that the Wide range output signal 808 is to be transmitted to any connected listening device 120, 121 (FIG. 1B), and the audio logic 705 transits as a signal 811 the Wide range analog signal 808. Furthermore, when the “Narrow” button 108 is selected, the micro-controller transmits a signal to the audio logic 705 indicating that the Narrow range output signal 809 is to be transmitted to any connected listening device 120, 121, and the audio logic 705 transmits as the signal 811 the Narrow range analog signal 809. This allows the user to listen to the signal 714 being detected in two differing modes with some noise removed and with additional noise removed.

Note that the output signals 710-713 may be represented by G1, G2, G3, and G4, respectively. Thus, with reference to FIG. 6, during operation the micro-controller 709 can display an indicator 624 and a symbol 620-623 indicating which gain range the circuit 700 is operating in. In addition, the display 101 may comprise an indicator 606, which indicates at what percentage of the gain range the circuit 700 is operating, which may also be indicated by the graphical component 607. In the exemplary display 101, the circuit 700 is operating in G4 at 50%, as indicated by indicator 624 and 606, respectively.

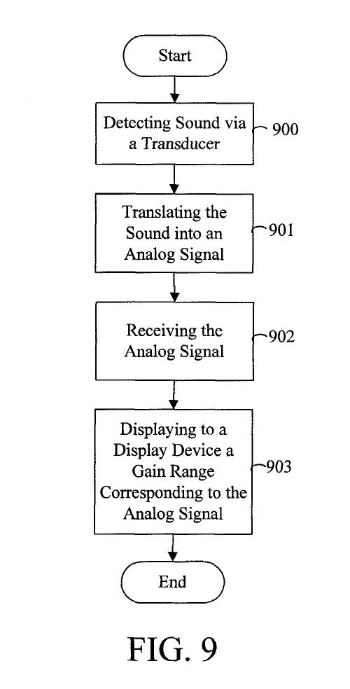

FIG. 9 depicts a flowchart of an exemplary method in accordance with an embodiment of the present disclosure. The first step 900 in the method is detecting sound via a transducer 701 (FIG. 7). The next step 901 is translating the sound into an analog signal 714 (FIG. 7).

Step 902 is detecting the analog signal indicative of the sound detected by the transducer 701. Step 903 is displaying to the display device 101 (FIG. 1) a gain range corresponding to the analog signal.

1. A leak detection apparatus, comprising:
a transducer arranged for detection of sound, the transducer translating the sound into an analog signal;
a display device; and
logic configured to receive the analog signal and display to the display device a gain range corresponding to the analog signal.

2. The leak detection apparatus of claim 1, wherein the logic is further configured to transmit an audible signal indicative of the analog signal received to a listening device.

3. The leak detection apparatus of claim 2, wherein the logic is further configured to filter the analog signal about a first frequency within a first bandwidth and transmit the filtered signal to the listening device based upon a user selection.

4. The leak detection apparatus of claim 2, wherein the logic is further configured to filter the analog signal about the first frequency within a second bandwidth and transmit the filtered signal to the listening device based upon a user selection.

5. The leak detection apparatus of claim 1, further comprising memory storing data indicative of particular sounds.

6. The leak detection apparatus of claim 5, wherein the logic displays to the display device indicators identifying the data indicative of the particular sounds.

7. The leak detection apparatus of claim 6, wherein the logic transmits audible data indicative of one of the particular sounds based upon a user input.

8. The leak detection apparatus of claim 1, wherein the logic is further configured to calibrate the leak detection apparatus when the leak detection apparatus is powered on.

9. The leak detection apparatus of claim 1, further comprising memory storing historical data associated in memory with a particular apparatus from which a leak was detected.

10. The leak detection apparatus of claim 9, wherein the historical data comprises data indicative of the strength of the leak detected.

11. The leak detection apparatus of claim 10, wherein the logic is configured to display to the display device data indicative of the leak detected based upon a user input.

12. A leak detection apparatus, comprising:
a transducer arranged for detection of sound, the transducer configured to transmit an analog signal indicative of the sound detected;
logic configured to generate a plurality of signals indicative of the analog signal centered about a particular frequency, the logic further configured to apply a gain to each of the plurality of signals, the gain applied to one signal differing from the gain applied to each of the other signal, the logic further configured to select one of the plurality of signals and display information related to the selected signal to a display device.

13. The leak detection apparatus of claim 12, wherein the logic comprises a plurality of amplifiers, each amplifier for applying a different gain to the analog signal.

14. The leak detection apparatus of claim 13, wherein the logic is further configured to remove noise components from the selected signal to generate a narrow signal.

15. The leak detection apparatus of claim 12, wherein the logic is further configured to output the selected signal or the generated narrow signal based upon a user input.

16. A leak detection method, comprising:
detecting sound via a transducer;
translating the sound into an analog signal;
receiving the analog signal; and
displaying to a display device a gain range corresponding to the signal.

17. The leak detection method of claim 16, further comprising transmitting an audible signal indicative of the analog signal received to a listening device.

18. The leak detection method of claim 17, further comprising filtering the analog signal about a first frequency within a first bandwidth; and transmitting the filtered signal to the listening device based upon a user selection.

19. The leak detection method of claim 18, further comprising
filtering the analog signal about the first frequency within a second bandwidth; and transmitting the filtered signal to the listening device based upon a user selection.

20. The leak detection method of claim 16, further comprising storing data indicative of particular sounds.

21. The leak detection method of claim 20, further comprising displaying to the display device indicators identifying the data indicative of the particular sounds.

22. The leak detection method of claim 21, further comprising transmitting audible data indicative of one of the particular sounds based upon a user input.
